(19) United States
(12) Patent Application Publication
(10) Pub. No.: US 2005/0272475 A1
(43) Pub. Date: Dec. 8, 2005

(54) Idle mode indication system and method for mobile terminal

(75) Inventor: Dong-Yeop Hahn, Seoul (KR)

Correspondence Address: JONATHAN Y. KANG, ESQ.;LEE, HONG, DEGERMAN, KANG & SCHMADEKA, P.C., 14th Floor, 801 S. Figueroa Street, Los Angeles, CA, 80017-5554, US

(73) Assignee: LG Electronics Inc.

(21) Appl. No.: 11/144,232

(22) Filed: Jun. 2, 2005

(30) Foreign Application Priority Data
Jun. 3, 2004 (KR) 10-2004-40453

(51) Int. Cl. H04M 1/00

(52) U.S. Cl. 455/566; 455/575.1

(57) ABSTRACT

An apparatus for indicating an idle mode in a mobile terminal is provided. The apparatus comprises at least one illuminator for illuminating a designated key on a keypad of a mobile communication terminal; and a control unit for turning on the illuminator for the designated key when the mobile terminal is in an idle mode.

### CROSS-REFERENCE TO RELATED APPLICATIONS

Pursuant to 35 U.S.C. § 119(a), this application claims the benefit of earlier filing date and right of priority to Korean Application No. 10-2004-0040453, filed on Jun. 3, 2004, the contents of which are hereby incorporated by reference herein in their entirety.

### FIELD OF THE INVENTION

The present invention relates to a mobile terminal, and more particularly to a method and apparatus for detecting an idle mode in a mobile terminal.

### BACKGROUND OF THE INVENTION

In general, a mobile terminal includes a Liquid Crystal Display (LCD). The mobile terminal has a light emitting device (hereinafter called “Display Back-light”) provided at the back of the LCD panel to project light on the LCD panel, such that the user can look at an image displayed on the display. In a related art, the display back-light is maintained in an ON state during an operating mode and the display back-light is in an OFF state during an idle mode.

When display back-light is off, the battery is not discharged. When the display back-light is in the OFF state, sometimes cannot be determined whether the mobile terminal is in a waiting state or in a power-off state (i.e., shutdown).

In order to solve this problem, some related art mobile terminals are equipped with a Light Emitting Diode (LED) for indicating an idle mode. If the LED (hereinafter called “Idle mode indicator”) is flashing, the user can determine that the mobile terminal is in the waiting state, else the mobile terminal is determined to be shutdown.

FIG. 1 is a diagram illustrating a bar-type mobile terminal in a related art, illustrating a PCB and a keypad back-light of the bar-type mobile terminal, wherein locations of an idle mode indicator 11 and keypad back-lights (e.g. # 1, #2, #3, #4, #5, etc.) are shown.

A problem in the above-described related art mobile terminal is that it includes an LED (idle mode indicator 11) in order to indicate an idle mode, wherein this separate LED drains electric power as it flashes to indicate the idle mode. This increases the number of parts and the cost of production because a part (LED for indicating an idle mode) is added.

### SUMMARY OF THE INVENTION

Features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, an apparatus for indicating an idle mode in a mobile terminal is provided. The apparatus comprises at least one illuminator for illuminating a designated key on a keypad of a mobile communication terminal; and a control unit for turning on the illuminator for the designated key when the mobile terminal is in an idle mode.

The control unit maintains a plurality of other illuminators for illuminating a plurality of keys on the keypad, other than the designated key, in an OFF state while the mobile terminal is in the idle mode. The control unit maintains a liquid crystal display of the mobile terminal in an OFF state, when the mobile terminal is in the idle mode. In one embodiment, the keypad is externally exposed to view. In another embodiment, the illuminator comprises material that transmits light.

In a certain embodiment, the mobile terminal comprises a keypad that is externally exposed to view. In some embodiments, the designated key comprises translucent material. The designated key may be a numeral key on the keypad or a special function key on the keypad.

In accordance with yet another embodiment, an idle state notification method for a mobile communication terminal comprises monitoring a mobile communication terminal to determine an idle state for the mobile communication terminal based on user interaction with the mobile communication terminal's user interface; switching the mobile communication terminal to an idle state, when no user interaction is detected after a threshold period is passed; and substantially limiting illumination of a plurality of illuminating devices used for illuminating the mobile terminal's user interface, except for at least one designated illuminating device, when the mobile communication terminal is in the idle state.

The method may further comprise increasing illumination of the plurality of illuminating devices, when the mobile communication terminal is not in the idle state. In one embodiment, the at least one designated illuminating device illuminates a numeral key on the mobile communication terminal's user interface. In another embodiment, the at least one designated illuminating device illuminates a non-numeral key on the mobile communication terminal's user interface. The at least one designated illuminating device may illuminate a random key of the mobile communication terminal's user interface.

These and other embodiments of the present invention will also become readily apparent to those skilled in the art from the following detailed description of the embodiments having reference to the attached figures, the invention not being limited to any particular embodiments disclosed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a diagram illustrating a bar-type mobile terminal.

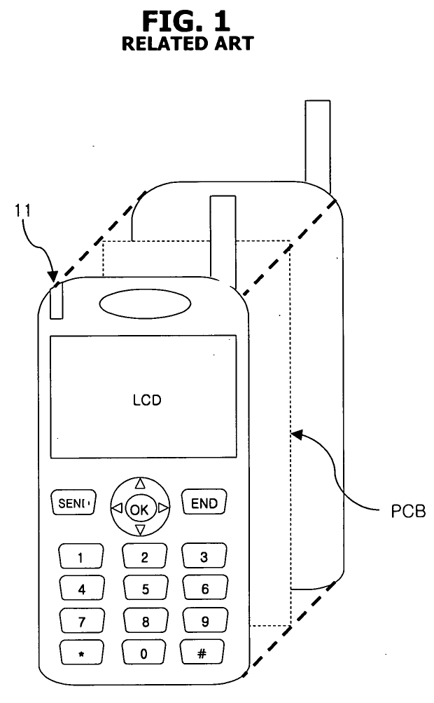

FIG. 2 illustrates a mobile terminal in accordance with one embodiment of the present invention.

FIG. 3 is a schematic diagram illustrating a PCB and illuminators for a keypad of a mobile terminal, in accordance with one embodiment of the present invention.

FIG. 4 is a flowchart illustrating a method for indicating an idle mode of the mobile terminal in accordance with one embodiment of the present invention.

### DETAILED DESCRIPTION OF THE PREFERRED EMBODIMENTS

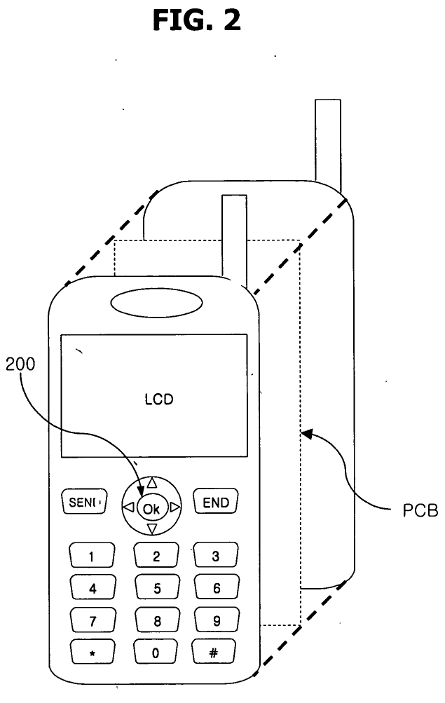

Referring to FIG. 2, a mobile terminal in accordance with one embodiment of the present invention does not include a separate LED for indicating the idle mode. As shown, an embodiment of the invention is directed to a terminal having an externally viewable keypad, such as a bar-type terminal, a slide-type terminal, or a folder-type terminal in which key-buttons are exposed externally.

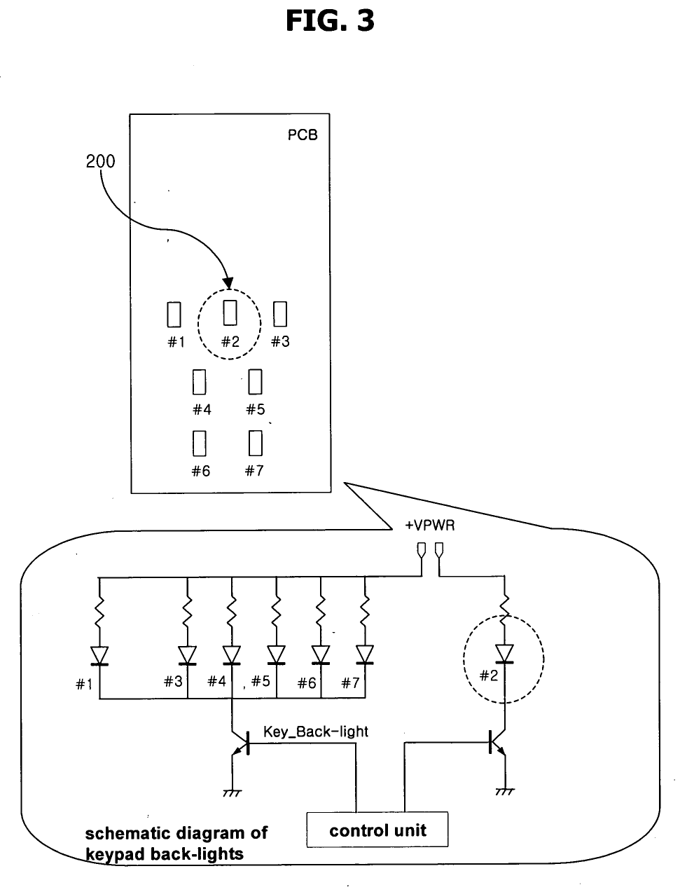

FIG. 3 is a diagram illustrating a schematic diagram of a PCB and keypad back-lights of the mobile terminal in accordance with one embodiment of the present invention. As shown in FIG. 3, the present invention supplies power sources to a plurality of illuminators, through independent electrical paths for the keypad (hereinafter “keypad back-lights”). In one embodiment, a keypad back-light (e.g., key #2) can operate as an idle mode indicator, instead of a separate LED implemented in the prior art devices.

An apparatus for indicating an idle mode of the mobile terminal in accordance with the present invention comprises a plurality of keypad back-lights (e.g., #1, #2, #3, #4, #5, #6 and #7). A control unit 100 is also included for maintaining one designed keypad back-light (e.g., #2) in an ON state, so as to indicate an idle mode when the mobile terminal is in the idle mode.

The control unit 100 blocks power sources supplied to other non-designated keypad back-lights (e.g., #1, #3, #4, #5, #6 and #7) by applying a low voltage of about 0.2V to a base of a transistor TR1. The control unit 100 maintains the designated keypad back-light in an ON state by applying a high voltage (e.g. more than 4.5V) to a base of a transistor TR2.

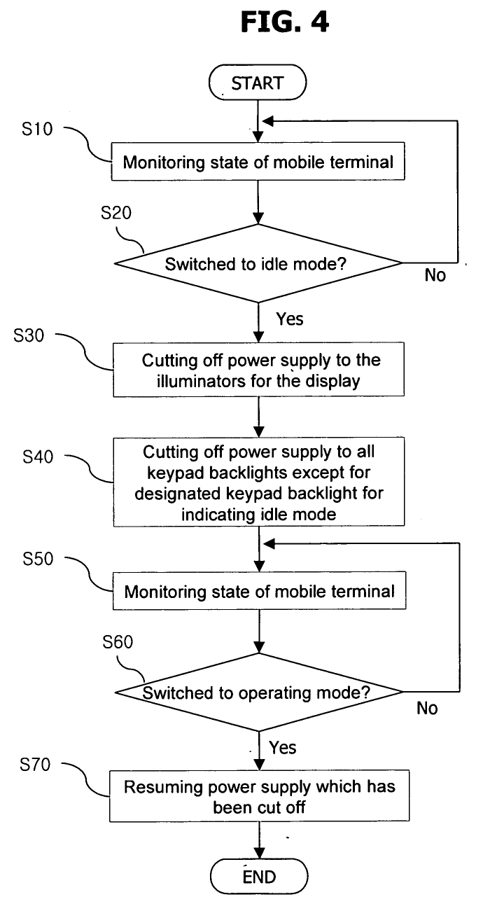

FIG. 4 is a flowchart illustrating a method for indicating an idle mode of the mobile terminal in accordance with one embodiment of the present invention. Hereinafter, with reference to FIG. 4, a method for indicating an idle mode of the mobile terminal in accordance with the present invention will be described.

In one embodiment, the on/off state of the mobile terminal is monitored (510). When the user finishes talking over the phone or when the user does not operate the keypad buttons anymore, the mobile terminal is switched to the idle mode (S20).

That is, when a communication mode of the mobile terminal is cancelled or when the user's button operation is not detected for a certain period of time, the control unit 100 switches the mobile terminal into the idle mode and cuts off the power supply to display illuminators, so that the display back-light is in an OFF state (S30).

In one embodiment, the control unit 100 cuts off the power supply to all the keypad back-lights (e.g., #1, #3, #4, #5, #6 and #7) except for the designated keypad back-light (e.g., #2) used for indicating the idle mode (S40).

While the mobile terminal maintains the idle mode, the power sources are supplied to the designated keypad back-light. The user thus can determine whether the mobile terminal is in a waiting state or in a power-off state by looking at on/off state of the designated keypad back-light.

While the mobile terminal is in the idle mode, the control unit 100 monitors user generated events such as call reception or the user's key operation (S50). If an event is detected, the control unit 100 resumes the power supply which has been cut off and turns the display back-light and the keypad back-lights (e.g., #1, #3, #4, #5, #6 and #7) on (see S60 and S70).

The designated keypad back-light in accordance with one embodiment of the present invention illuminates an ‘OK’ button 200. While the mobile terminal is in the idle mode, the OK button 200 serves as an idle mode indicator by transmitting light of the designated keypad back-light.

In one embodiment, another keypad button can be used as the idle mode indicator in addition or in place of the OK button 200. A keypad button serving as the idle mode indicator should be a material (transparent or translucent) which transmits light. The designated keypad back-light is located at the rear surface of the keypad button serving as the idle mode indicator, in one embodiment.

As described so far, the present invention can save electric power which is caused by operating an extra LED for indicating an idle mode by operating one or more designated keypad back-lights as an idle mode indicator. In addition, the present invention can reduce the cost of production by reducing the number of parts of the terminal.

The method and apparatus for indicating an idle mode in a mobile terminal may be embodied in several forms without departing from the spirit or essential characteristics described herein. It should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

1. An apparatus for indicating an idle mode in a mobile terminal, the apparatus comprising:
at least one illuminator for illuminating a designated key on a keypad of a mobile terminal to indicate an idle mode; and
a control unit for turning on said at least one illuminator for the designated key when the mobile terminal is in an idle mode,
wherein the designated key is an integral part of mobile terminal's user interface, the designated key having another function in addition to indicating an idle mode.

2. The apparatus of claim 1, wherein the control unit controls a plurality of other illuminators for illuminating a plurality of keys, other than the designated key, wherein the control unit switches the plurality of keys to an OFF state, when the mobile terminal is in the idle mode.

3. The apparatus of claim 1, wherein the control unit switches a liquid crystal display of the mobile terminal in an OFF state, when the mobile terminal is in the idle mode.

4. The apparatus of claim 1, wherein the keypad is externally exposed to view.

5. The apparatus of claim 1, wherein the illuminator comprises material that transmits light.

6. A method for indicating an idle mode in a mobile terminal, the method comprising:
supplying power to a first illuminator for a designated key on a keypad of a mobile terminal for indicating an idle mode;
limiting supply of power to second illuminators for illuminating keys on the keypad other than the designated key, when the mobile terminal is in the idle mode; and
resuming power supply to the second illuminators, when the mobile terminal is switched to an operating mode.

7. The method of claim 6, wherein the mobile terminal comprises a keypad that is externally exposed to view.

8. The method of claim 6, wherein the designated key comprises translucent material.

9. The method of claim 6, wherein the designated key is a numeral key on the key pad.

10. The method of claim 6, wherein the designated key is a special function key on the key pad.

11. An idle state notification method for a mobile communication terminal comprising:
monitoring a mobile communication terminal to determine an idle state for the mobile communication terminal based on user interaction with the mobile communication terminal's user interface;
switching the mobile communication terminal to an idle state, when no user interaction is detected after a threshold period is passed; and
substantially limiting illumination of a plurality of illuminating devices used for illuminating the mobile terminal's user interface, except for at least one designated illuminating device, when the mobile communication terminal is in the idle state.

12. The method of claim 11, further comprising:
increasing illumination of the plurality of illuminating devices, when the mobile communication terminal is not in the idle state.

13. The method of claim 11, wherein the at least one designated illuminating device illuminates a numeral key on the mobile communication terminal's user interface.

14. The method of claim 11, wherein the at least one designated illuminating device illuminates a non-numeral key on the mobile communication terminal's user interface.

15. The method of claim 11, wherein the at least one designated illuminating device illuminates a random key of the mobile communication terminal's user interface.
